(19) United States
(12) Patent Application Publication
(10) Pub. No.: US 2011/0117437 A1
(43) Pub. Date: May 19, 2011

(54) POSITIVE ELECTRODE FOR NONAQUEOUS ELECTROLYTE SECONDARY BATTERY, METHOD FOR FABRICATING THE SAME, AND NONAQUEOUS ELECTROLYTE SECONDARY BATTERY

(76) Inventors: Kozo Watanabe, Osaka (JP); Masaki Deguchi, Hyogo (JP)

(21) Appl. No.: 13/003,173

(22) PCT Filed: Mar. 4, 2010
(86) PCT No.: PCT/JP2010/001512

§ 371 Date: Jan. 7, 2011

(30) Foreign Application Priority Data
Apr. 27, 2009 (JP) 2009-108201

(51) Int. Cl. H01M 4/58; H01M 4/26; B05D 5/12

(52) U.S. Cl. 429/231.9; 29/623.1; 427/78; 427/77

(57) ABSTRACT

The invention provides a positive electrode for a nonaqueous electrolyte secondary battery which is capable of alleviating generation of gas during charge/discharge with a nonaqueous electrolyte solution penetrated therein, and a method for fabricating the same.

The positive electrode for the nonaqueous electrolyte secondary battery includes a current collector, and a positive electrode material mixture layer 22 formed on the current collector. The method includes reacting acidic gas or an acidic solution with the positive electrode which has been pressed by rolling, thereby providing a positive electrode for a nonaqueous electrolyte secondary battery including a positive electrode active material 23 which is capable of reversibly inserting and extracting lithium ions as the positive electrode material mixture layer, and in which lithium salt 24a, 25a except for lithium hydroxide and lithium carbonate is present at least on fracture surfaces 24, 25 of the positive electrode active material 23.

### TECHNICAL FIELD

The present invention relates to a positive electrode for a nonaqueous electrolyte secondary battery, a method for fabricating the same, and a nonaqueous electrolyte secondary battery.

### BACKGROUND ART

Because of their reduced weight, high electromotive force, and high energy density, lithium ion secondary batteries representing nonaqueous electrolyte secondary batteries have been in demand as a driving power source for various types of mobile electronic devices and mobile communication devices, such as cellular phones, digital cameras, video cameras, notebook computers, etc.

A lithium ion secondary battery includes a positive electrode containing lithium-containing composite oxide, a negative electrode containing a negative electrode active material capable of inserting and extracting lithium, a separator which separates the positive and negative electrodes, and a nonaqueous electrolyte solution.

Lithium-containing composite oxide may be, for example, LiNiO₂, LiCoO₂, etc. In particular, lithium nickel-based composite oxide, such as LiNiO₂, is suitable for a positive electrode active material for a nonaqueous secondary battery due to its high theoretical capacity, and good storage characteristics. The lithium nickel-based composite oxide contains high valence cobalt Co⁴⁺ and nickel NO⁴⁺ which are highly reactive in charging the battery.

The lithium-containing composite oxide includes lithium hydroxide as a raw material, and is prepared by mixing an excessive amount of lithium hydroxide with transition metal, and baking the mixture. Therefore, unreacted lithium hydroxide may remain on the surfaces of the particles. When the lithium-containing composite oxide is handled in the air, lithium hydroxide may react with carbon dioxide contained in the air to produce lithium carbonate on the surfaces of the positive electrode active material particles, and lithium carbonate remains on the particle surfaces.

When lithium hydroxide and lithium carbonate exist in the positive electrode active material as described above, and enter the battery, lithium hydroxide may react with the nonaqueous electrolyte solution, or oxidative decomposition of lithium carbonate may occur in a high temperature environment. As a result, gas is generated, and battery characteristics may deteriorate due to expansion of the battery, and the resulting deformation of the electrode group.

As a solution to the above-described problem, a technology of alleviating generation of gas due to decomposition of the electrolyte solution has been disclosed. According to this technology, the active material in the powder state is cleansed with an acidic solution before the fabrication of the electrode, or acidic gas is blown on the surface of the positive electrode active material to produce neutral lithium salt, such as lithium sulfate etc., and alleviate production of lithium hydroxide and lithium carbonate (see, e.g., Patent Document 1).

Another technology of coating the surface of the active material with neutral lithium salt, such as lithium phosphate etc. has been disclosed (see, e.g., Patent Documents 2 and 3).

### Citation List

### Patent Document

Patent Document 1: Japanese Patent Publication No. 2003-123755

Patent Document 2: Japanese Patent Publication No. 2005-190996

Patent Document 3: Japanese Patent Publication No. 2006-318815

### SUMMARY OF THE INVENTION

### Technical Field

As described in Patent Documents 1-3, when a battery is fabricated using a positive electrode formed without pressing, lithium phosphate or lithium sulfate which coat the surface of the active material alleviate the reaction with the nonaqueous electrolyte solution.

However, in a lithium ion secondary battery which has recently been used for mobile devices, a material mixture layer is formed by applying an active material to a current collector, and the material mixture layer is pressed to increase filling density, thereby increasing energy density. A study by the inventors of the present invention discovered that the pressing may cause the generation of gas in the battery even if the positive electrode active material fabricated by any of the technologies disclosed by Patent Documents 1-3 is used.

In view of the foregoing, an object of the present invention is to provide a positive electrode for a nonaqueous electrolyte secondary battery which is capable of alleviating the generation of gas during charge/discharge with a nonaqueous electrolyte solution penetrated therein, and a method for fabricating the positive electrode.

### Solution to the Problem

To achieve the above-described object, the positive electrode for the nonaqueous electrolyte secondary battery of the present invention includes: a current collector; and a positive electrode material mixture layer formed on the current collector, wherein the positive electrode material mixture layer contains a particulate positive electrode active material which is capable of reversibly inserting and extracting lithium ions, and has a density of 2.4 g/cm³ or higher, and lithium salt except for lithium hydroxide and lithium carbonate is present at least on a surface of the particulate positive electrode active material.

A nonaqueous electrolyte secondary battery of the present invention includes the positive electrode for the nonaqueous electrolyte secondary battery, a negative electrode, and a nonaqueous electrolyte.

According to a first aspect of the invention, a method for fabricating a positive electrode for a nonaqueous electrolyte secondary battery includes: forming a positive electrode material mixture layer containing a particulate positive electrode active material capable of reversibly inserting and extracting lithium ions on a current collector; compressing the positive electrode material mixture layer to a predetermined thickness; and blowing acidic gas except for carbon dioxide gas on the positive electrode material mixture layer. The acidic gas is gas which is acid when dissolved in water.

According to a second aspect of the invention, a method for fabricating a positive electrode for a nonaqueous electrolyte secondary battery includes: forming a positive electrode material mixture layer containing a particulate positive electrode active material capable of reversibly inserting and extracting lithium ions on a current collector; compressing the positive electrode material mixture layer to a predetermined thickness; spraying an acidic solution except for a carbon dioxide solution on the positive electrode material mixture layer; and drying the positive electrode material mixture layer after the spraying.

According to a third aspect of the invention, a method for fabricating a nonaqueous electrolyte secondary battery for a nonaqueous electrolyte secondary battery includes: forming a positive electrode material mixture layer containing a particulate positive electrode active material capable of reversibly inserting and extracting lithium ions on a current collector; compressing the positive electrode material mixture layer to a predetermined thickness; immersing the positive electrode material mixture layer into an acidic solution except for a carbon dioxide solution; and drying the positive electrode material mixture layer after the immersing.

### Advantages of the Invention

With use of the positive electrode for the nonaqueous electrolyte secondary battery of the present invention, lithium salt except for lithium hydroxide and lithium carbonate is present on the surface of the particulate positive electrode active material in the high density positive electrode. This can alleviate production of lithium hydroxide and lithium carbonate, thereby preventing contact between lithium hydroxide and lithium carbonate with the nonaqueous electrolyte solution, and alleviating generation of gas during charge/discharge.

### BRIEF DESCRIPTION OF THE DRAWINGS

FIG. 1 is a partial cross-sectional view schematically illustrating a positive electrode active material of a positive electrode according to an embodiment.

FIG. 2 is a schematic side view illustrating a process of a first treatment method for treating the positive electrode of the embodiment with acidic gas.

FIG. 3 is a schematic side view illustrating a process of a second treatment method for treating the positive electrode of the embodiment with an acidic solution.

FIG. 4 is a schematic side view illustrating a process of a third treatment method for treating the positive electrode of the embodiment with an acidic solution.

FIG. 5 is a schematic side view illustrating a process of a fourth treatment method for treating the positive electrode of the embodiment with an acidic solution.

FIG. 6 is a partially developed perspective view illustrating a nonaqueous electrolyte secondary battery of the embodiment.

FIG. 7 is a schematic side view illustrating a process of a treatment method for treating a positive electrode of a comparative example.

FIG. 8 is a schematic side view illustrating a process of another treatment method for treating the positive electrode of a comparative example.

FIG. 9 is a partial cross-sectional view schematically illustrating a positive electrode active material of the positive electrode of a comparative example.

FIG. 10 is a table illustrating characteristics of batteries of examples.

FIG. 11 is a table illustrating characteristics of batteries of examples, and batteries of comparative examples.

### DESCRIPTION OF EMBODIMENTS

How the present invention has been achieved will be described before description of embodiments.

In a high capacity lithium ion secondary battery which has recently been used in mobile devices, a positive electrode material mixture comprising a particulate active material, a conductive agent, and a binder is prepared, and is applied to a current collector to form a material mixture layer. Then, the material mixture is pressed to increase filling density, thereby increasing energy density. The pressing may break the particles of the positive electrode active material due to pressure applied thereto.

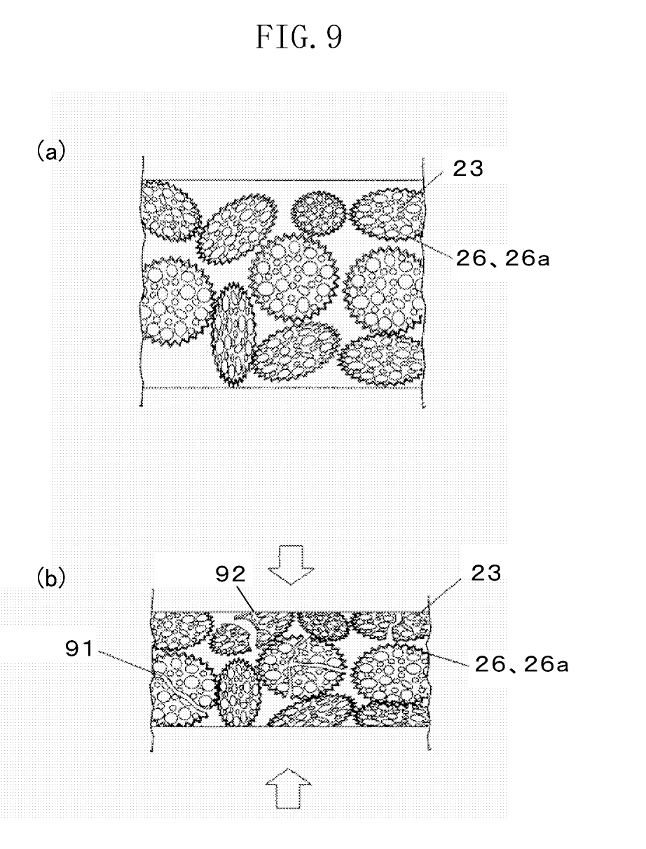

According to the technologies disclosed by Patent Documents 1 to 3, particles of a positive electrode active material 23 are broken due to the pressing even if surfaces 26 of the particles the positive electrode active material 23 are coated with lithium salt 26a before the pressing as shown in FIG. 9(a). Then, as shown in FIG. 9(b), water reacts with fracture surfaces 91, 92 to produce lithium hydroxide and lithium carbonate. Thus, the inventors of the present application have found that generation of gas in the battery during a cycle test etc. is difficult to alleviate when the pressed positive electrode is used. Patent Documents 1 to 3 fail to disclose or suggest this finding.

To solve the newly found problem, the inventors of the present application have conducted various studies, and have achieved the present invention. An example embodiment of the present invention will be described below.

In a positive electrode for a nonaqueous electrolyte secondary battery according to the example embodiment, a positive electrode material mixture layer is compressed through a compression process to have a density of 2.4 g/cm³ or higher. Some of particles of a positive electrode active material are broken through the compression, and have fracture surfaces. The fracture surface exists not only inside the positive electrode material mixture layer, but also in a surface of the positive electrode material mixture layer. In the example embodiment, acid is allowed to act on the surface of the particulate positive electrode active material including the fracture surface to convert lithium hydroxide and lithium carbonate existing on the surface to other lithium salt, thereby providing lithium salt except for lithium hydroxide and lithium carbonate on the surface of the particulate positive electrode active material. The acid used in this process does not include carbonic acid. This can prevent contact between lithium hydroxide and lithium carbonate, and a nonaqueous electrolyte solution, thereby alleviating the generation of gas during charge/discharge. Thus, battery characteristics are prevented from deterioration due to expansion of the battery, and the resulting deformation of the electrode.

There are various methods for acting acid on the surface of the particulate positive electrode active material. Examples thereof include, for example, a method for blowing acidic gas on the surface, a method for spraying an acidic solution on the surface, a method for immersing the positive electrode into an acidic solution, etc. Use of the acidic solution is advantageous in that a rate of production of lithium salt can be controlled by adjusting the concentration of acid. The acid is allowed to act on the particulate positive electrode active material after the fracture surface is generated in the particulate positive electrode active material. The acid may be present near the positive electrode active material when the fracture surface is being generated.

An Embodiment of the present invention will be described in detail with reference to the drawings. The invention is not limited to the following description as long as the invention is based on the fundamental features described in the specification.

### First Embodiment

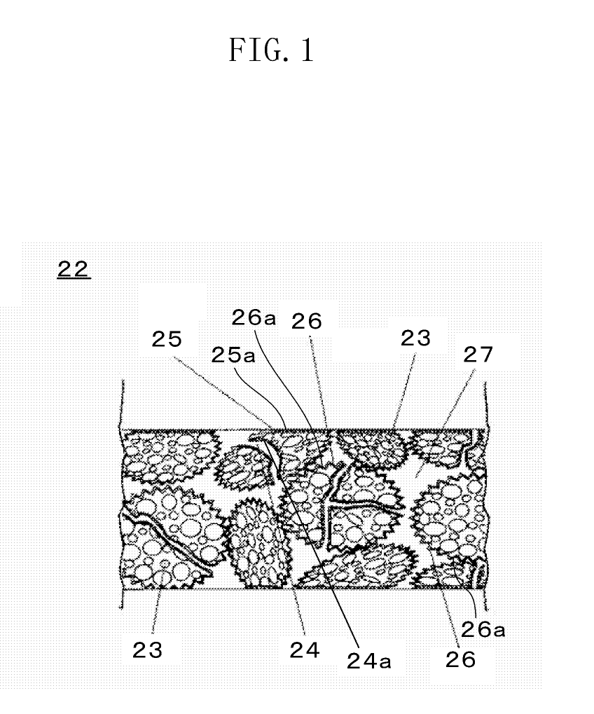

A positive electrode for a nonaqueous electrolyte secondary battery according to a first embodiment will be described in detail with reference to FIG. 1.

FIG. 1 is a conceptual cross-sectional view illustrating a positive electrode material mixture layer 22 comprising the positive electrode for the nonaqueous electrolyte secondary battery of this embodiment. In general, the positive electrode material mixture layer 22 is formed on each surface of a current collector (not shown). FIG. 1 shows the structure of only one of the positive electrode material mixture layers. The positive electrode material mixture layer 22 includes at least a particulate positive electrode active material 23, a fracture surface 24 of the particulate active material 23 inside the positive electrode material mixture layer 22, a fracture surface 25 of the active material 23 in a surface of the positive material mixture layer, neutral lithium salt 24a, 25a, 26a except for lithium hydroxide and lithium carbonate existing on a surface 26 of the positive electrode active material, and a mixture portion 27 comprising a binder and a conductive agent.

A feature of this embodiment is that neutral lithium salt 24a, 25a, 26a exists on the fracture surface 24 of the positive electrode active material 23 which is inside the positive electrode material mixture layer 22, and is crushed by a pressing process as shown in FIG. 1, the fracture surface 25 of the positive electrode active material in a surface portion of the positive electrode material mixture layer 22, and the surface 26 of the positive electrode active material.

A method for fabricating the positive electrode for the nonaqueous electrolyte secondary battery of this embodiment will be described below.

A particulate positive electrode active material obtained by baking, a particulate positive electrode active material which has not been cleansed using an acidic solution, or on which acidic gas has not been sprayed in advance, or a particulate positive electrode active material which has been cleansed using the acidic solution, or on which the acidic gas has been sprayed in advance is dispersed and mixed with a conductive agent, and a binder to prepare positive electrode material mixture paste.

The prepared positive electrode material mixture paste is applied to a current collector, and is dried to form a positive electrode material mixture layer.

Then, the obtained positive electrode material mixture layer and the current collector are pressed to form a positive electrode of a predetermined thickness. The pressing brings a density of the positive electrode material mixture layer to 2.4 g/cm³ to 4.1 g/cm³, both inclusive.

In the pressing process of the positive electrode material mixture layer, or in the subsequent process, acidic gas is allowed to penetrate into the positive electrode material mixture layer, or the positive electrode material mixture layer is impregnated with an acidic solution.

The acidic gas is preferably at least one selected from the group consisting of sulfur oxide, nitrogen oxide, hydrogen chloride, and chlorine. Examples of sulfur oxide include SO₂, SO₃, etc. Examples of nitrogen oxide include NO, NO₂, N₂O₄, etc. The acidic solution is preferably a solution containing at least one type of acid ions selected from the group consisting of sulfuric acid ions, sulfurous acid ions, nitric acid ions, chloride ions, and phosphoric acid ions. An aqueous solution of sulfuric acid, nitric acid, hydrochloric acid, ammonium sulfate, ammonium nitrate, ammonium chloride, phosphoric acid, etc., which are easily obtained, and are inexpensive, is preferably used as the acidic solution. The acidic gas does not include carbon dioxide. The acidic solution does not include an aqueous solution of carbon dioxide.

An acid treatment is a treatment for producing lithium salt except for lithium hydroxide and lithium carbonate in the positive electrode active material by neutralization reaction between lithium hydroxide and lithium carbonate existing on the surface of the active material, and the acidic gas or the acidic solution. This treatment alleviates production of lithium carbonate, neutralizes lithium hydroxide, and alleviates decomposition of an electrolyte.

The production of lithium salt except for lithium hydroxide and lithium carbonate by the acid treatment can be checked by surface analysis, such as XPS etc.

This provides a positive electrode for a nonaqueous electrolyte secondary battery having good storage characteristics.

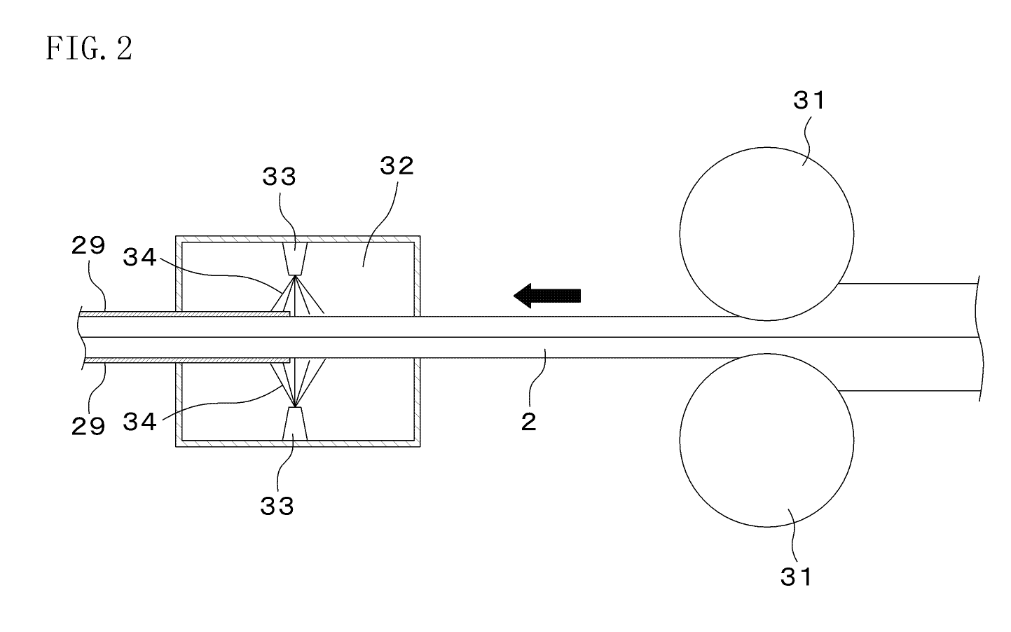

Referring to FIGS. 2-5, first to fourth treatment methods for impregnating the surface of the positive electrode material mixture layer with the acidic gas or the acidic solution will be described in detail below.

### (First Treatment Method)

A first treatment method using the acidic gas will be described with reference to FIG. 2.

FIG. 2 is a side view illustrating a process of impregnating the positive electrode material mixture layer with the acidic gas by the first treatment method. First, a positive electrode 2 is pressed by rolling using two rollers 31 to a total thickness of 160 μm. Then, the positive electrode 2 is placed in a chamber 32 filled with acidic gas 34 sprayed from a nozzle 33, and the acidic gas 34 is sprayed on the positive electrode 2 for penetration. The surface of the positive electrode material mixture layer on which the acidic gas 34 was sprayed is converted to an acid-treated surface 29.

The acidic gas 34 is preferably a gas containing at least one selected from sulfur oxide, nitrogen oxide, chlorine oxide. The gas sprayed from the nozzle 33 may contain gas except for the acidic gas (e.g., inert gas such as noble gas, nitrogen gas, etc.). The sprayed gas preferably has an acidic gas concentration of 50% or higher. The acidic gas 34 may be sprayed simultaneously with the rolling, or may be sprayed simultaneously and after the rolling. In the first treatment method, the positive electrode material mixture layer is dried in a shorter time as compared with the second to fourth treatment methods described below.

### (Second Treatment Method)

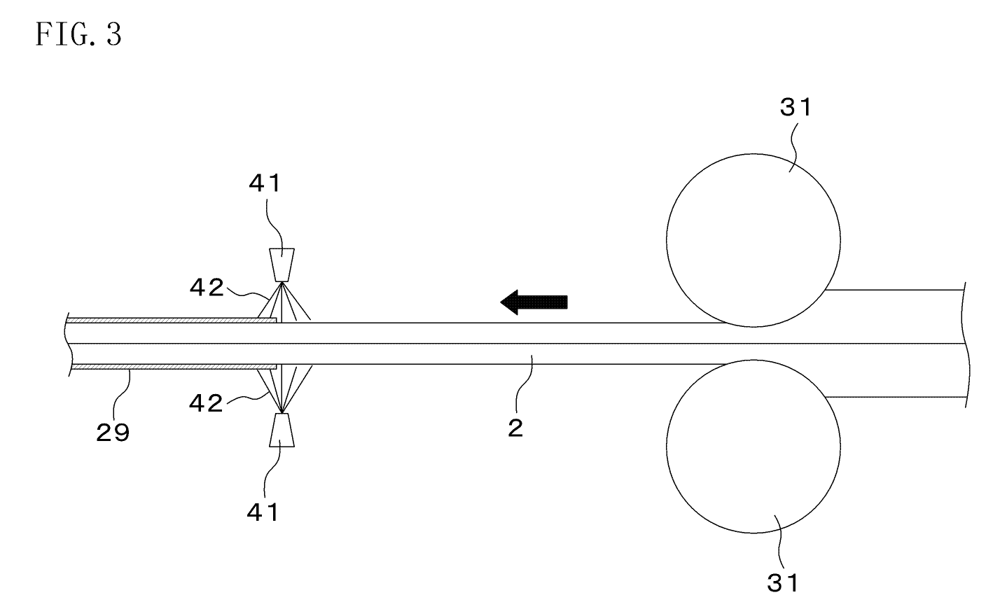

FIG. 3 is a side view illustrating a process of impregnating the positive electrode material mixture layer with the acidic solution by the second treatment method.

In the second treatment method, an acidic solution 42 is sprayed from a nozzle 41 on the rolled positive electrode material mixture layer of the positive electrode 2 for impregnation, thereby producing lithium salt on the surface of the particulate positive electrode active material. Then, the positive electrode 2 is dried.

The acidic solution used in the second to fourth treatments preferably contains at least one selected from sulfuric acid, nitric acid, and hydrochloric acid in a concentration of 0.01 N to 0.0005 N, both inclusive. The acidic solution 42 may be sprayed simultaneously with the rolling, or may be sprayed simultaneously and after the rolling.

### (Third Treatment Method)

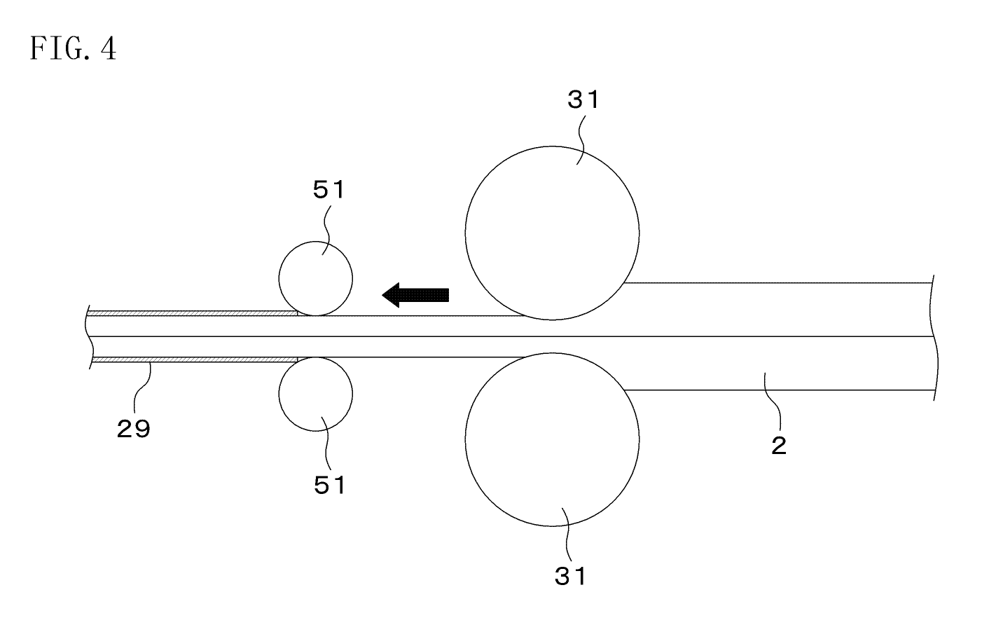

A third treatment method will be described with reference to FIG. 4.

FIG. 4 is a side view illustrating a process of impregnating the positive electrode material mixture layer with the acidic solution by the third treatment method.

As shown in FIG. 4, the positive electrode 2 is pressed by rolling using two rollers 31 to a total thickness of 160 μm.

Then, two transfer rollers 51 on which the acidic solution exists are brought into contact with the surfaces of the rolled positive electrode material mixture layer of the positive electrode 2 to apply the acidic solution to the surfaces of the positive electrode 2, thereby producing lithium salt on the surface of the particulate positive electrode active material. Then, the positive electrode 2 is dried.

### (Fourth Treatment Method)

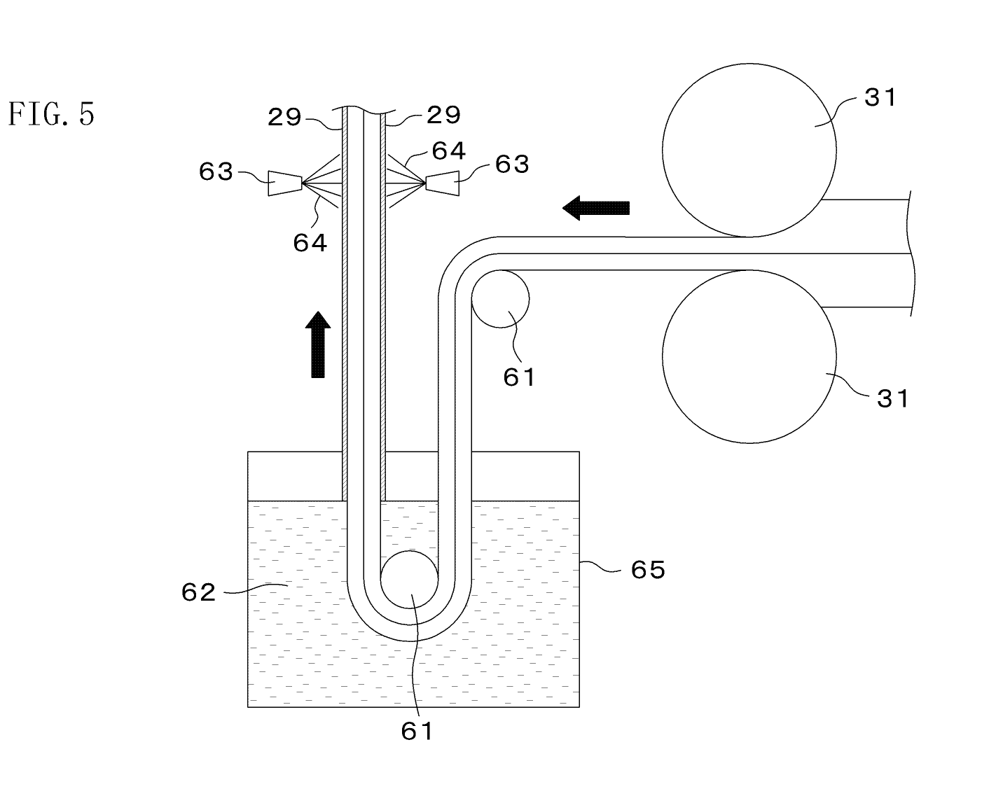

A fourth treatment method will be described with reference to FIG. 5.

FIG. 5 is a side view illustrating a process of impregnating the positive electrode material mixture layer with the acidic solution by the fourth treatment method.

As shown in FIG. 5, the positive electrode 2 is pressed by rolling using two rollers 31 to a total thickness of 160 μm.

Then, the rolled positive electrode 2 is placed in an immersion bath 65 filled with an acidic solution 62, and is immersed in the acidic solution 62. Thus, the acidic solution 62 is applied to the surface of the positive electrode material mixture layer, and the positive electrode 2 is removed from the immersion bath 65.

Then, an excess of the acidic solution 62 is removed by spraying inert gas 64 such as argon gas from a spray nozzle 63, thereby controlling the amount of the acidic solution 62 applied to the positive electrode.

Then, water is removed from the acidic solution 62 by drying with air having a temperature of 120° C. and a dew point of −40° C., air having a dew point of −40° C. and from which carbon dioxide is removed, or inert gas, thereby forming a positive electrode. A process of removing water from the acidic solution 62 by drying after the impregnation with the acidic solution 62 is preferably performed in a short time, e.g., within 300 seconds.

In this manner, lithium salt is formed on the surface of the positive electrode active material in the positive electrode material mixture layer. The surface of the positive electrode active material includes a fracture surface of the broken particulate positive electrode active material. Lithium salt does not contain lithium hydroxide and lithium carbonate.

The positive electrode for the nonaqueous electrolyte secondary batter of this embodiment can be formed by the above-described treatments.

The positive electrode 2 used in this embodiment preferably includes, a positive electrode material mixture layer 22 containing, as a positive electrode active material 23, lithium-containing composite oxide represented by the general formula LiₓM_{y}N_{1-y}O₂ (1) (wherein M and N is at least one selected from the group consisting of Co, Ni, Mn, Cr, Fe, Mg, Al, and Zn, M≠N, 0.98≦x≦1.10, 0≦y≦1), and a current collector which is made of Al or an Al alloy, and carries the positive electrode material mixture layer 22.

Element N is at least one element selected from the group consisting of alkaline earth elements, transition metal elements, rare earth elements, group IIIb elements, and group IVb elements. The element N improves thermal stability etc. of the lithium-containing composite oxide.

Examples of the lithium-containing composite oxide represented by the general formula (1) where M and N is Ni, Co, and Al include, for example, lithium nickel-based composite oxide represented by the following formula (1-1).

LiNi_{0.8}Co_{0.15}Al_{0.05}O₂ (1-1)

Examples of the lithium-containing composite oxide represented by the general formula (1) where M and N is Ni, Co, and Mn include, for example, lithium nickel-based composite oxide represented by the following formulae (1-2) and (1-3).

LiNi_{0.5}Co_{0.2}Mn_{0.3}O₂ (1-2)

LiNi_{1/3}Co_{1/3}Mn_{1/3}O₂ (1-3)

The lithium-containing composite oxide represented by the general formula (1) is not limited by the above-described lithium nickel-based composite oxides. For example, lithium-containing composite oxide represented by the following formulae (1-4) and (1-5) may also be used.

LiMn₂O₄ (1-4)

LiCoO₂ (1-5)

In a method for fabricating the lithium-containing composite oxide represented by the general formula (1), a compound containing the elements represented by M and N in the general formula (1) and a lithium compound are baked in a baking process.

Examples of the lithium compound include, for example, lithium hydroxide, lithium carbonate, lithium nitrate, lithium peroxide, etc. In particular, lithium hydroxide or lithium carbonate is suitably used in the manufacture of the lithium nickel-based composite oxide.

The positive electrode material mixture layer 22 constituting the positive electrode 2 together with the current collector contains, as the positive electrode active material 23, lithium-containing composite oxide primarily containing nickel or cobalt (Ni/Co-based lithium-containing composite oxide, such as LiCoO₂, LiNiO₂, LiMn₂O₄, or a mixture or a composite of them).

The shape of the lithium-containing composite oxide constituting the positive electrode active material 23 is not particularly limited. For example, primary particles may constitute the positive electrode active material 23, or secondary particles made of agglomerated primary particles may constitute the positive electrode active material 23. The secondary particles may be made of various types of agglomerated positive electrode active material particles.

An average particle diameter of the lithium-containing composite oxide used as the positive electrode active material 23 is not particularly limited. For example, the average particle diameter is preferably 1-30 μm, more preferably 10-30 μm. The average particle diameter may be measured by, for example, a wet laser particle size analyzer manufactured by Microtrac etc. In this case, a 50% value measured by volume (median value: D50) can be considered as the average particle diameter.

The positive electrode material mixture layer 22 further contains a mixture portion 27 containing a binder and a conductive agent. Examples of the conductive agent include graphites such as natural graphite and artificial graphite, carbon blacks such as acetylene black, Ketchen black, channel black, furnace black, lamp black, thermal black, etc., conductive fibers such as carbon fibers and metal fibers, powders of metal such as carbon fluoride, aluminum, etc., conductive whiskers such as zinc oxide, potassium titanate, conductive metal oxide such as titanium oxide, organic conductive materials such as a phenylene derivative, etc. The positive electrode material mixture layer 22 preferably contains 0.2-50 weight percent (wt. %) of the conductive agent, particularly 0.2-30 wt. %, relative to the positive electrode active material.

Examples of the binder include, for example, polyvinylidene fluoride (PVDF), polytetrafluoroethylene, polyethylene, polypropylene, aramid resin, polyamide, polyimide, polyamide-imide, polyacrylonitrile, polyacrylic acid, poly(methyl acrylate), poly(ethyl acrylate), poly(hexyl acrylate), polymethacrylic acid, poly(methyl methacrylate), poly(ethyl methacrylate), poly(hexyl methacrylate), polyvinyl acetate, polyvinyl pyrrolidone, polyether, polyether sulfone, hexafluoropolypropylene, styrene-butadiene rubber, carboxymethyl cellulose, etc.

A copolymer of two or more materials selected from tetrafluoroethylene, hexafluoroethylene, hexafluoropropylene, perfluoro(alkyl vinyl ether), vinylidene fluoride, chlorotrifluoroethylene, ethylene, propylene, pentafluoropropylene, fluoromethyl vinyl ether, acrylic acid, and hexadiene may also be used. A mixture of two or more of these substances may also be used.

A current collector used for the positive electrode 2 may be made of aluminum (Al), carbon, conductive resin, etc. These materials may be surface-treated with carbon etc.

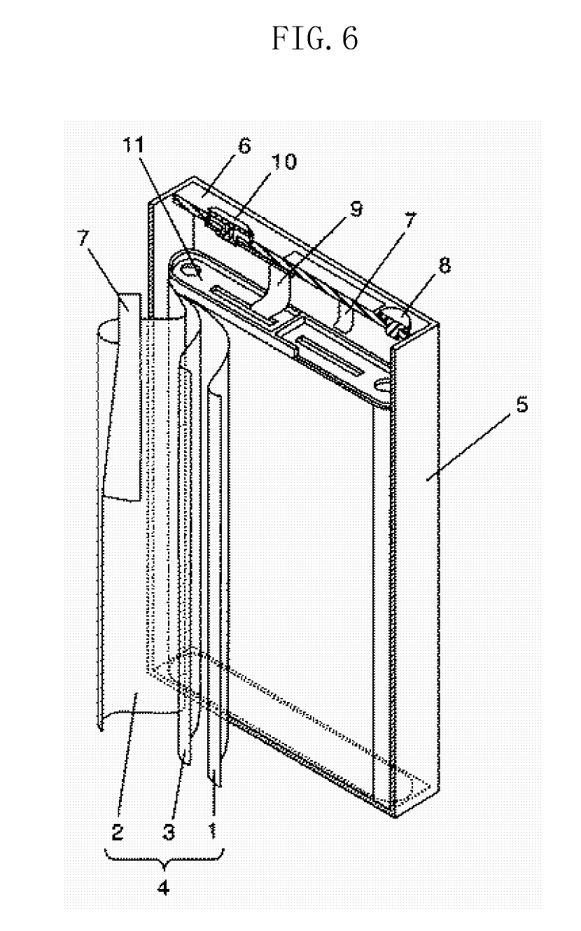

FIG. 6 is a partially developed perspective view illustrating a nonaqueous electrolyte secondary battery of the embodiment.

As shown in FIG. 6, a rectangular nonaqueous electrolyte secondary battery (hereinafter referred to as a “battery”) includes a negative electrode 1, a positive electrode 2 which faces the negative electrode 1, and reduces lithium ions during discharge, and a separator 3 interposed between the negative electrode 1 and the positive electrode 2 to prevent direct contact between the negative electrode 1 and the positive electrode 2. The negative electrode 1 and the positive electrode 2 are wound with the separator 3 interposed therebetween to constitute an electrode group 4. The electrode group 4 is contained in a battery case 5 together with a nonaqueous electrolyte (not shown). A frame 11 made of a resin, for example, is arranged at an upper end of the electrode group 4 to isolate the electrode group 4 from a sealing plate 6, and a positive electrode lead 7 from a negative electrode lead 9. At an opening of the battery case 5 which also functions as an external connection terminal for the positive electrode, a sealing plate 6 including an external connection terminal for the negative electrode 10 for connecting the negative electrode lead 9 to an external device, and a plug 8 for blocking an injection hole for injecting the nonaqueous electrolyte is arranged. The negative electrode 1 includes a current collector and a negative electrode material mixture layer, and the positive electrode 2 includes a current collector and a positive electrode material mixture layer.

The current collector of the negative electrode 1 may be metal foil made of stainless steel, nickel, copper, titanium, etc., or a thin film made of carbon or a conductive resin. The current collector may be surface-treated with carbon, nickel, titanium, etc.

The negative electrode material mixture layer contains at least a negative electrode active material capable of inserting and extracting lithium ions. The negative electrode active material may be a carbon material such as graphite, amorphous carbon, etc. Alternatively, a material capable of inserting and extracting a large amount of lithium ions at a lower potential than a potential of the positive electrode active material, such as silicon (Si), tin (Sn), etc., may be used. The advantages of the present embodiment can be provided by using negative electrode active composite materials made of any combination of a simple substance, an alloy, a compound, a solid solution, a silicon-containing material, and a tin-containing material as long as these materials have the above-described characteristics. In particular, the silicon-containing material is preferable due to its high capacity density and inexpensiveness. Examples of the silicon-containing material include Si, SiOₓ (0.05<x<1.95), or an alloy, a compound, or a solid solution of Si or SiOₓ in which part of Si is substituted with at least one selected from the group consisting of B, Mg, Ni, Ti, Mo, Co, Ca, Cr, Cu, Fe, Mn, Nb, Ta, V, W, Zn, C, N, and Sn. Examples of the tin-containing material include Ni₂Sn₄, Mg₂Sn, SnOₓ (0<x<2), SnO₂, SnSiO₃, LiSnO, etc.

These materials may be used alone, or in combination of two or more materials to constitute the negative electrode active material. Example of the combination of two or more materials constituting the negative electrode active material include, a compound containing Si, oxygen and nitrogen, a composite of two or more compounds containing Si and oxygen in different composition ratios, etc. Among them, SiOₓ (0.3≦x≦1.3) is preferable due to its high discharge capacity density, and an expansion coefficient in charging lower than that of Si alone.

The negative electrode material mixture layer contains at least a composite negative electrode active material including carbon nanofiber (hereinafter referred to as “CNF”) attached to a surface of a negative electrode active material capable of inserting and extracting lithium ions. CNF is attached or fixed to the surface of the negative electrode active material. This reduces resistance to current collection, and maintains high electron conduction in the battery.

The negative electrode material mixture layer further contains a binder. Examples of the binder include, for example, polyvinylidene fluoride (PVDF), polytetrafluoroethylene, polyethylene, polypropylene, aramid resin, polyamide, polyimide, polyamide imide, polyacrylonitrile, polyacrylic acid, poly(methyl acrylate), poly(ethyl acrylate), poly(hexyl acrylate), polymethacrylic acid, poly(methyl methacrylate), poly(ethyl methacrylate), poly(hexyl methacrylate), polyvinyl acetate, polyvinyl pyrrolidone, polyether, polyether sulfone, hexafluoropolypropylene, styrene-butadiene rubber, carboxymethyl cellulose, etc. Further, a copolymer of two or more materials selected from the group consisting of tetrafluoroethylene, hexafluoroethylene, hexafluoropropylene, perfluoroalkyl vinyl ether, vinylidene fluoride, chlorotrifluoroethylene, ethylene, propylene, pentafluoropropylene, fluoromethyl vinyl ether, acrylic acid, and hexadiene may also be used.

When necessary, a conductive agent may be mixed with the negative electrode material mixture layer, for example, graphites such as flake-like graphite including natural graphite, artificial graphite, expansion graphite, etc., carbon blacks such as acetylene black, Ketchen black, channel black, furnace black, lamp black, thermal black, etc., conductive fibers such as carbon fiber, metal fiber, etc., powders of metal such as copper, nickel, etc., an organic conductive material such as a polyphenylene derivative, etc.

As the nonaqueous electrolyte solution (not shown), an electrolyte solution prepared by dissolving a solute in an organic solvent, and a so-called polymeric electrolyte layer in which the nonaqueous electrolyte solution is contained, and is immobilized by a polymer can be used.

When at least the nonaqueous electrolyte solution is used, a separator 3 made of nonwoven fabric or a microporous film made of polyethylene, polypropylene, aramid resin, amideimide, polyphenylene sulfide, polyimide, etc., is provided between the positive electrode 2 and the negative electrode 1, and the separator 3 is preferably impregnated with the electrolyte solution. A heat resistant filler such as alumina, magnesia, silica, titania, etc., may be provided inside or on the surface of the separator 3. A heat resistant layer made of the filler and a binder similar to that used in the positive electrode 2 and the negative electrode 1 may be provided separately from the separator 3.

The material for the nonaqueous electrolyte is selected based on oxidation-reduction potentials of the positive electrode active material and negative electrode active material. The solute preferably used for the nonaqueous electrolyte may be salts generally used in the lithium batteries, for example, LiPF₆, LiBF₄, LiClO₄, LiA1Cl₄, LiSbF₆, LiSCN, LiCF₃SO₃, LiN(CF₃CO₂), LiN(CF₃SO₂)₂, LiAsF₆, LiB₁₀Cl₁₀, lower aliphatic lithium carboxylate, LiF LiCl, LiBr, LiI, chloroborane lithium, borates such as bis(1,2-benzendiolate(2-)-O,O′)lithium borate, bis(2,3-naphthalene diolate(2-)-O,O′)lithium borate, bis(2,2′-biphenyldiolate(2-)-O,O′)lithium borate, bis(5-fluoro-2-olate-1-benzenesulfonic acid-O,O′)lithium borate, etc., (CF₃SO₂)₂NLi, LiN(CF₃SO₂)(C₄F₉SO₂), (C₂F₅SO₂)₂NLi, sodium tetraphenylborate, etc.

The organic solvent for dissolving the salts may be a solvent generally used in the lithium batteries, for example, one of the following materials, or a compound of more than one of the following materials including ethylene carbonate (EC), propylene carbonate, butylene carbonate, vinylene carbonate, dimethyl carbonate (DMC), diethyl carbonate, ethyl methyl carbonate (EMC), dipropyl carbonate, methyl formate, methyl acetate, methyl propionate, ethyl propionate, dimethoxyethane, γ-butyrolactone, γ-valerolactone, 1,2-diethoxyethane, 1,2-dimethoxyethane, ethoxymethoxyethane, trimethoxymethane, tetrahydrofuran derivatives such as tetrahydrofuran, 2-methyl tetrahydrofuran, etc., dimethyl sulfoxide, dioxolane derivatives such as 1,3-dioxolane, 4-methyl-1,3-dioxolane, etc., formamide, acetoamide, dimetyl formamide, acetonitrile, propylnitrile, nitromethane, ethyl monoglyme, phosphoric acid triester, acetate, propionate, sulfolane, 3-methyl sulfolane, 1,3-dimethyl-2-imidazolidinone, 3-methyl-2-oxazolidinone, propylene carbonate derivatives, ethyl ether, diethyl ether, 1,3-propane sultone, anisole, fluorobenzene, etc.

The organic solvent may further contain an additive such as vinylene carbonate, cyclohexylbenzene, biphenyl, diphenyl ether, vinyl ethylene carbonate, divinyl ethylene carbonate, phenyl ethylene carbonate, diallyl carbonate, fluoroethylene carbonate, catechol carbonate, vinyl acetate, ethylene sulfate, propane sultone, trifluoropropylene carbonate, dibenzofuran, 2,4-difluoroanisole, o-terphenyl, m-terphenyl, etc.

The nonaqueous electrolyte may be a solid electrolyte prepared by mixing the above-described solute with one of the following polymeric materials, or a mixture of more than one of the polymeric materials including polyethylene oxide, polypropylene oxide, polyphosphazene, polyaziridine, polyethylene sulfide, polyvinyl alcohol, polyvinylidene fluoride, polyhexafluoropropylene, etc. The nonaqueous electrolyte may be a gelled nonaqueous electrolyte prepared by mixing the solute with the above-described organic solvent. Further, the nonaqueous electrolyte may be a solid electrolyte made of an inorganic material such as lithium nitride, lithium halide, lithium oxysalt, Li₄SiO₄, Li₄SiO₄—LiI—LiOH, Li₃PO₄—Li₄SiO₄, Li₂SiS₃, Li₃PO₄—Li₂S—SiS₂, a phosphorus sulfide compound, etc.

In this embodiment, as shown in FIG. 6, a rectangular battery is used as the nonaqueous electrolyte secondary battery, and an amount of generated gas is evaluated based on variations in thickness of the battery case. Expansion of the battery case due to the gas generated by a reaction between the positive electrode active material and moisture is not derived from the shape of the battery, and the expansion occurs similarly in nonaqueous electrolyte secondary batteries of different shapes, such as button-shaped batteries, flat batteries, etc.

Specific examples of this embodiment will be described below.

### EXAMPLE 1

### Fabrication of Positive Electrode Active Material LiNi_{0.80}Co_{0.15}Al_{0.05}O₂

To an aqueous solution of nickel sulfate, cobalt sulfate and aluminum sulfate were added to prepare a saturated aqueous solution. The saturated aqueous solution contained nickel, cobalt, and aluminum in the molar ratio of 80:15:5. Sodium hydroxide was added to the saturated aqueous solution to neutralize the solution, thereby producing a precipitate of ternary system hydroxide Ni_{0.80}Co_{0.15}Al_{0.05}(OH)₂. The obtained precipitate was filtered, washed with water, and was dried at 80° C.

The ternary system hydroxide was heated in atmospheric air at 600° C. for 10 hours to obtain ternary system oxide Ni_{0.80}Co_{0.15}Al_{0.05}O. Then, lithium hydroxide monohydrate was added to the ternary system oxide, and the obtained mixture was baked in an oxygen flow at 800° C. for 10 hours to obtain lithium-containing composite oxide (LiNi_{0.80}Co_{0.15}Al_{0.05}O₂) as a baked product. Lithium hydroxide and lithium carbonate were present in the obtained lithium-containing composite oxide. Then, the obtained lithium-containing composite oxide was pulverized into particles (powders in a macroscopic sense) having an average particle diameter (a median diameter D₅₀ measured by volume—this notation will be used below) of 20 μm.

### Fabrication of Positive Electrode

One kilogram of the obtained lithium-containing composite oxide powder was stirred with 0.5 kg of a solution of PVDF (#1320, 12 wt. % of solid content, manufactured by KUREHA CORPORATION) in N-methyl-2-pyrrolidone (NMP), 40 g of acetylene black, and an appropriate amount of NMP at 30° C. for 30 minutes using a double arm kneader to prepare positive electrode material mixture paste.

The obtained positive electrode material mixture paste was applied to each surface of 20 μm thick aluminum foil as a current collector, was dried at 120° C. for 15 minutes, and was pressed by rolling to a total thickness of 160 μm. Rollers used for the rolling had a diameter of 40 cm, and a linear pressure representing a pressure for the rolling was 10000 N/cm.

Then, the rolled positive electrode material mixture layer was impregnated with nitrogen oxide gas as acidic gas by the first treatment method. In that case, Ar and the nitrogen oxide gas were mixed with the ratio of the nitrogen oxide gas set to 50 vol %, and the positive electrode material mixture layer was passed through the mixture gas in 20 seconds.

The obtained positive electrode plate was cut into a size insertable into a rectangular battery case of 50 mm in height, 34 mm in width, and 5 mm in thickness, thereby obtaining a positive electrode provided with a positive electrode lead. The fabrication of the positive electrode was performed in an environment where a dew point of −30° C. or lower was kept.

### Fabrication of Negative Electrode

Three kilogram of artificial graphite was stirred with 200 g of BM-400B (a dispersion of styrene-butadiene rubber, 40 wt. % of solid content, manufactured by ZEON CORPORATION), 50 g of carboxymethyl cellulose (CMC), and an appropriate amount of water using a double arm kneader to prepare negative electrode material mixture paste.

The obtained negative electrode material mixture paste was applied to each surface of 12 μtm thick copper foil as a current collector, was dried at 120° C., and was rolled to a total thickness of 160 μm.

The obtained negative electrode plate was cut into a size insertable into a rectangular battery case of 50 mm in height, 34 mm in width, and 5 mm in thickness, thereby obtaining a negative electrode provided with a negative electrode lead.

### Fabrication of Battery

The negative electrode 1 and the positive electrode 2 fabricated in the above-described manner were wound with a separator 3 interposed therebetween to constitute a spiral-shaped electrode group 4. A composite film of polyethylene and polypropylene (2300, manufactured by Celgard, 25 μtm thick) was used as the separator 3.

Then, an opening of a battery case 5 was sealed with a sealing plate 6 provided with an external connection terminal for the negative electrode 10, a nonaqueous electrolyte was injected through an injection hole, and the injection hole was sealed with a plug 8. Thus, a rectangular battery of 50 mm in height, 34 mm in width, and 5 mm in thickness was fabricated. A design capacity of the battery was 900 mAh.

The nonaqueous electrolyte secondary battery including the positive electrode formed in the above-described manner is referred to as Battery 1.

### EXAMPLE 2

### Fabrication of Positive Electrode Active Material LiNi_{1/3}Co_{1/3}Mn_{1/3}O₂

To an aqueous solution of nickel sulfate, cobalt sulfate and manganese sulfate were added to prepare a saturated aqueous solution. The saturated aqueous solution contained nickel, cobalt, and manganese in the molar ratio of 1:1:1. Sodium hydroxide was added to the saturated aqueous solution to neutralize the solution, thereby producing a precipitate of ternary system hydroxide Ni_{1/3}Co_{1/3}Mn_{1/3}(OH)₂. The obtained precipitate was filtered, was washed wish water, and was dried at 80° C.

The ternary system hydroxide was heated in atmospheric air at 600° C. for 10 hours to obtain ternary system oxide Ni_{1/3}Co_{1/3}Mn_{1/3}O. Then, lithium hydroxide was added to the ternary system oxide, and the obtained mixture was baked in an oxygen flow at 800° C. for 10 hours to obtain lithium-containing composite oxide (LiNi_{1/3}Co_{1/3}Mn_{1/3}O₂) as a baked product. Lithium hydroxide and lithium carbonate were present in the obtained lithium-containing composite oxide. The obtained lithium-containing composite oxide was pulverized to have an average particle diameter of 20 μm.

A nonaqueous electrolyte secondary battery fabricated in the same manner as described in Example 1 except that LiMn_{1/3}Ni_{1/3}Co_{1/3}O₂ was used as the positive electrode active material is referred to as Battery 2.

### EXAMPLE 3

### Fabrication of Positive Electrode Active Material LiCoO₂

Lithium carbonate and cobalt oxide were mixed in such a manner that the molar amounts of Li and Co would be equal after the baking, and the mixture was baked in an air flow at 900° C. for 10 hours to obtain lithium-containing composite oxide (LiCoO₂) as a baked product. Lithium hydroxide and lithium carbonate were present in the obtained lithium-containing composite oxide. The obtained lithium-containing composite oxide was pulverized to have an average particle diameter of 20 μm.

A nonaqueous electrolyte secondary battery fabricated in the same manner as described in Example 1 except that LiCoO₂ was used as the positive electrode active material is referred to as Battery 3.

### EXAMPLE 4

### Fabrication of Positive Electrode Active Material LiNi_{0.50}Co_{0.20}Mn_{0.30}O₂

To an aqueous solution of nickel sulfate, cobalt sulfate and manganese sulfate were added to prepare a saturated aqueous solution. The saturated aqueous solution contained nickel, cobalt, and manganese in the molar ratio of 50:20:30. Sodium hydroxide was added to the saturated aqueous solution to neutralize the solution, thereby producing a precipitate of ternary system hydroxide Ni_{0.50}Co_{0.20}Mn_{0.30}(OH)₂. The obtained precipitate was filtere washed with water, and was dried at 80° C.

The ternary system hydroxide was heated in atmospheric air at 600° C. for 10 hours to obtain ternary system oxide Ni_{0.50}Co_{0.20}Mn_{0.30}O. Then, lithium hydroxide was added to the ternary system oxide, and the obtained mixture was baked in an air flow at 800° C. for 10 hours to obtain lithium-containing composite oxide (LiNi_{0.50}Co_{0.20}Mn_{0.30}O₂) as a baked product. Lithium hydroxide and lithium carbonate were present in the obtained lithium-containing composite oxide. The obtained lithium-containing composite oxide was pulverized to have an average particle diameter of 20 μm.

A nonaqueous electrolyte secondary battery fabricated in the same manner as described in Example 1 except that LiNi_{0.50}Co_{0.20}Mn_{0.30}O₂ was used as the positive electro active material is referred to as Battery 4.

### EXAMPLE 5

### Fabrication of Active Material LiMn₂O₄

LiOH and γ-Mn₂O₃ were mixed in such a manner that the molar ratio of Li and Mn would be 1:2 after the baking, and the mixture was baked in an air flow at 750° C. for 12 hours to obtain lithium-containing composite oxide (LiMn₂O₄) as a baked product. Lithium hydroxide and lithium carbonate were present in the obtained lithium-containing composite oxide. The obtained lithium-containing composite oxide was pulverized to have an average particle diameter of 20 μm.

A nonaqueous electrolyte secondary battery fabricated in the same manner as described in Example 1 except that Li₂MnO₄ was used as the positive electrode active material is referred to as Battery 5.

### EXAMPLE 6

### Fabrication of Positive Electrode Active Material

To an aqueous solution of nickel sulfate, cobalt sulfate and aluminum sulfate were added to prepare a saturated aqueous solution. The saturated aqueous solution contained nickel, cobalt, and aluminum in the molar ratio of 80:15:5. Sodium hydroxide was added to the saturated aqueous solution to neutralize the solution, thereby producing a precipitate of ternary system hydroxide Ni_{0.80}Co_{0.15}Al_{0.05}(OH)₂. The obtained precipitate was filtered washed with water, and was dried at 80° C.

The ternary system hydroxide was heated in atmospheric air at 600° C. for 10 hours to obtain ternary system oxide Ni_{0.80}Co_{0.15}Al_{0.05}O. Then, lithium hydroxide monohydrate was added to the ternary system oxide, and the obtained mixture was baked in an oxygen flow at 800° C. for 10 hours to obtain lithium-containing composite oxide (LiNi_{0.80}Co_{0.15}Al_{0.05}O₂) as a baked product. Lithium hydroxide and lithium carbonate were present in the obtained lithium-containing composite oxide. One hundred grams of the obtained lithium-containing composite oxide powder and 100 mL of water as a cleansing solution were placed in a stirrer, and were stirred for 1 hour.

After the stirring, water was removed by filtration, a solid content in the resulting product was adjusted to 98 wt. % or higher, and water was further removed by drying under reduced pressure to obtain LiNi_{0.80}Co_{0.15}Al_{0.05}O₂ having a moisture content of 350 ppm. The obtained lithium-containing composite oxide was pulverized to have an average particle diameter of 20 μm (a median diameter D₅₀ measured by volume—this notation will be used below). A nonaqueous electrolyte secondary battery fabricated in the same manner as described in Example 1 except that LiNi_{0.80}Co_{0.15}Al_{0.05}O₂ obtained as described above was used is referred to as Battery 6.

### EXAMPLE 7

### Fabrication of Positive Electrode Active Material

To an aqueous solution of nickel sulfate, cobalt sulfate and aluminum sulfate were added to prepare a saturated aqueous solution. The saturated aqueous solution contained nickel, cobalt, and aluminum in the molar ratio of 80:15:5. Sodium hydroxide was added to the saturated aqueous solution to neutralize the solution, thereby producing a precipitate of ternary system hydroxide Ni_{0.80}Co_{0.15}Al_{0.05}(OH)₂. The obtained precipitate was filtered, washed wish water, and was dried at 80° C.

The ternary system hydroxide was heated in atmospheric air at 600° C. for 10 hours to obtain ternary system oxide Ni_{0.80}Co_{0.15}Al_{0.05}O. Then, lithium hydroxide monohydrate was added to the ternary system oxide, and the obtained mixture was baked in an oxygen flow at 800° C. for 10 hours to obtain lithium-containing composite oxide (LiNi_{0.80}Co_{0.15}Al_{0.05}O₂) as a baked product. Lithium hydroxide and lithium carbonate were present in the obtained lithium-containing composite oxide. One hundred grams of the obtained lithium-containing composite oxide powder and 1000 mL of N-methyl-2-pyrrolidone (NMP) as a cleansing solution were placed in a stirrer, and were stirred for 1 hour.

After the stirring, the cleansing solution was removed by filtration, a solid content in the resulting product was adjusted to 98 wt. % or higher, and the cleansing solution was further removed by drying under pressure to obtain LiNi_{0.80}Co_{0.15}Al_{0.05}O₂. The obtained lithium-containing composite oxide was pulverized to have an average particle diameter of 20 μm (a median diameter D₅₀ measured by volume—this notation will be used below). A nonaqueous electrolyte secondary battery fabricated in the same manner as described in Example 1 except that LiNi_{0.80}Co_{0.15}Al_{0.05}O₂ obtained as described as was used is referre as Battery 7.

### EXAMPLE 8

A nonaqueous electrolyte secondary battery fabricated in the same manner as described in Example 1 except that sulfur oxide gas was used as the acidic gas is referred to as Battery 8.

### EXAMPLE 9

A nonaqueous electrolyte secondary battery fabricated in the same manner as described in Example 1 except that hydrogen chloride was used as the acidic gas is referred to as Battery 9.

### EXAMPLE 10

Positive electrode material mixture paste was prepared in the same manner as described in Example 1 except that LiNi_{0.80}Co_{0.15}Al_{0.05}O₂ was used as the positive electrode active material, and the rolling was performed to obtain a product having a total thickness of 160 μm.

The rolled positive electrode material mixture layer was impregnated with nitric acid by the second treatment method. Specifically, the positive electrode material mixture layer was allowed to pass through atomized 0.001 N nitric acid for 5 seconds, and was dried for 1 minute in atmospheric air at a dew point of −40° C., and a temperature of 120° C., from which carbon dioxide had been removed.

The obtained positive electrode plate was cut into a size insertable into a rectangular battery case of 50 mm in height, 34 mm in width, and 5 mm in thickness to obtain a positive electrode provided with a positive electrode lead. The fabrication of the positive electrode was performed in an environment where a dew point of −50° C. or lower was kept.

A nonaqueous electrolyte secondary battery including the positive electrode formed in the above-described manner is referred to as Battery 10.

### EXAMPLE 11

A positive electrode material mixture paste was prepared in the same manner as described in Example 1 except that LiNi_{0.80}Co_{0.15}Al_{0.05}O₂ was used as the positive electrode active material, and the rolling was performed to obtain a product having a total thickness of 160 μm.

The rolled positive electrode material mixture layer was impregnated with nitric acid by the third treatment method. Specifically, the positive electrode material mixture layer was allowed to pass through a 0.001 N nitric acid solution for 5 seconds, and was dried for 1 minute in atmospheric air at a dew point of −40° C. and a temperature of 120° C., from which carbon dioxide had been removed.

The obtained positive electrode plate was cut into a size insertable into a rectangular battery case of 50 mm in height, 34 mm in width, and 5 mm in thickness to obtain a positive electrode provided with a positive electrode lead. The fabrication of the positive electrode was performed in an environment where a dew point of −50° C. or lower was kept.

A nonaqueous electrolyte secondary battery including the positive electrode formed in the above-described manner is referred to as Battery 11.

### EXAMPLE 12

A positive electrode material mixture paste was prepared in the same manner as described in Example 1 except that LiNi_{0.80}Co_{0.15}Al_{0.05}O₂ was used as the positive electrode active material, and the rolling was performed to obtain a product having a total thickness of 160 μm.

The rolled positive electrode material mixture layer was impregnated with nitric acid by the fourth treatment method. Specifically, a 0.001 N nitric acid solution was applied to transfer rollers 51 at a ratio of 1.5 g/m², and the nitric acid solution was transferred to the rolled positive electrode. Then, the positive electrode material mixture layer was dried for 1 minute in air at a dew point of −40° C. and a temperature of 120° C., from which carbon dioxide had been removed.

The obtained positive electrode plate was cut into a size insertable into a rectangular battery case of 50 mm in height, 34 mm in width, and 5 mm in thickness to obtain a positive electrode provided with a positive electrode lead. The fabrication of the positive electrode was performed in an environment where a dew point of −50° C. or lower was kept.

A nonaqueous electrolyte secondary battery including the positive electrode formed in the above-described manner is referred to as Battery 12.

### EXAMPLE 13

A nonaqueous electrolyte secondary battery fabricated in the same manner as described in Example 10 except that 1% of perchloric acid was used as the acidic solution is referred to as Battery 13.

### EXAMPLE 14

A nonaqueous electrolyte secondary battery fabricated in the same manner as described in Example 10 except that 0.05 N phosphoric acid was used as the acidic solution is referred to as Battery 14.

### EXAMPLE 15

A nonaqueous electrolyte secondary battery fabricated in the same manner as described in Example 10 except that 0.1 mol/l of an aqueous solution of ammonium nitrate was used as the acidic solution is referred to as Battery 15.

### COMPARATIVE EXAMPLE 1

The active material LiNi_{0.80}Co_{0.15}Al_{0.05}O₂ used in Example 1 was used as the positive electrode active material. One kilogram of LiNi_{0.80}Co_{0.15}Al_{0.05}O₂ powder was brought into contact with 1 m³ of nitrogen oxide gas while stirring. A positive electrode material mixture layer made of the active material which was acid-treated in the powder state was pressed by rolling in the same manner as described in Example 1 to form a positive electrode of an adjusted thickness, and a nonaqueous electrolyte secondary battery was fabricated without performing the acid treatment after the rolling. This battery is referred to as Battery C1. Battery C1 is different from the battery of Example 1 in that the acid treatment was performed on the positive electrode active material powder, and the acid treatment was not performed after the rolling of the positive electrode material mixture layer.

### COMPARATIVE EXAMPLE 2

A nonaqueous electrolyte secondary battery fabricated by acid-treating the active material powder in the same manner as described in Comparative Example 1 except that LiMn_{1/3}Ni_{1/3}Co_{1/3}O₂ was used as the positive electrode active material is referred to as Battery C2.

### COMPARATIVE EXAMPLE 3

A nonaqueous electrolyte secondary battery fabricated by acid-treating the active material powder in the same manner as described in Comparative Example 1 except that LiCoO₂ was used as the positive electrode active material is referred to as Battery C3.

### COMPARATIVE EXAMPLE 4

A nonaqueous electrolyte secondary battery fabricated by acid-treating the active material powder in the same manner as described in Comparative Example 1 except that LiNi_{0.50}Co_{0.20}Mn_{0.30}O₂ was used as the positive electrode active material is referred to as Battery C4.

### COMPARATIVE EXAMPLE 5

A nonaqueous electrolyte secondary battery fabricated by acid-treating the active material powder in the same manner as described in Comparative Example 1 except that Li₂MnO₄ was used as the positive electrode active material is referred to as Battery C5.

### COMPARATIVE EXAMPLE 6

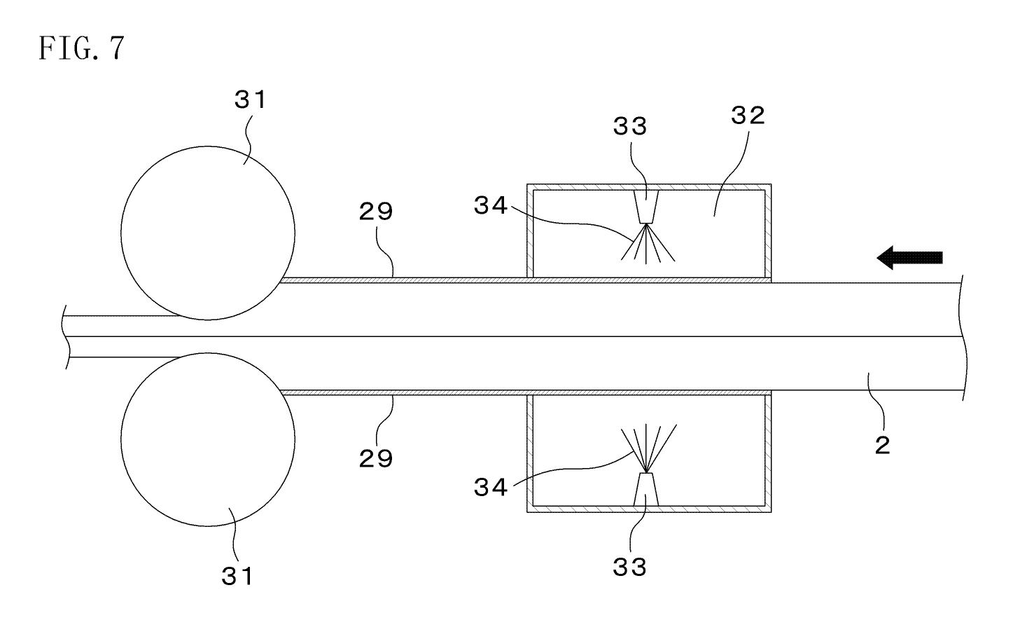

Comparative Example 6 will be described with reference to FIG. 7.

A positive electrode 2 which was not pressed by rolling was acid-treated in a chamber 32 under the same conditions as described in Example 1. Then, the positive electrode was allowed pass between rollers 31 to press the positive electrode under the same conditions as described in Example 1, thereby fabricating a positive electrode of an adjusted thickness of 160 μm. Thus, a nonaqueous electrolyte secondary battery was fabricated to have the structure similar to that of Example 1. This battery is referred to as Battery C6.

### COMPARATIVE EXAMPLE 7

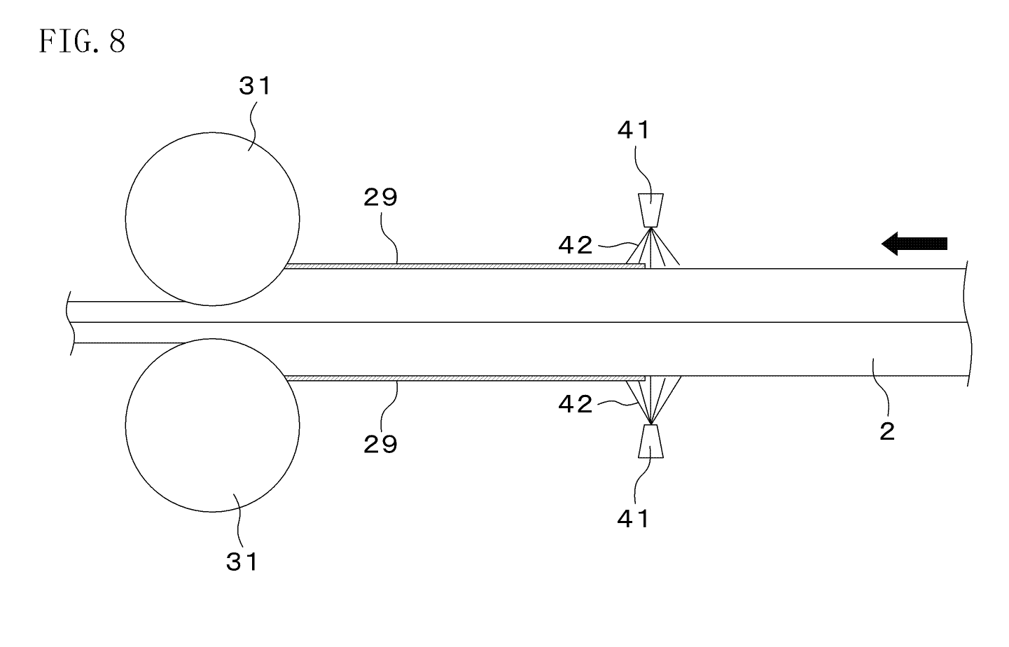

Comparative Example 7 will be described with reference to FIG. 8.

A positive electrode 2 which was not pressed by rolling was acid-treated by spraying an acidic solution from a nozzle 41 under the same conditions as described in Example 10, and was dried. Then, the positive electrode was allowed to pass between rollers 31 to press the positive electrode under the same conditions as described in Example 2, thereby fabricating a positive electrode of an adjusted thickness of 160 μm. Thus, a nonaqueous electrolyte secondary battery was fabricated to have the structure similar to that of Example 10. This battery is referred to as Battery C7.

### COMPARATIVE EXAMPLE 8

The positive electrode material mixture layer of Example 11, which was not pressed by rolling after application to the current collector, and drying, was acid-treated by the third treatment method under the same conditions as described in Example 11. Then, the positive electrode material mixture layer was rolled under the same conditions as described in Example 11 to form a positive electrode of an adjusted thickness. Then, a nonaqueous electrolyte secondary battery was fabricated to have the structure similar to that of Example 11 without performing the acid treatment. This is referred to as Battery C8.

### COMPARATIVE EXAMPLE 9

The positive electrode material mixture layer of Example 12, which was not rolled after application to the current collector, and drying, was acid-treated by the fourth treatment method under the same conditions as described in Example 12. Then, the positive electrode active material layer was rolled under the same conditions as described in Example 12 to form a positive electrode of an adjusted thickness. Then, a nonaqueous electrolyte secondary battery was fabricated to have the structure similar to that of Example 12 without performing the acid treatment. This battery is referred to as Battery C9.

### EXAMPLE 16

LiNi_{0.80}Co_{0.15}Al_{0.05}O₂ which was acid-treated in Comparative Example 1 was used as the positive electrode active material, and the positive electrode was acid-treated with nitrogen oxide gas after the rolling in the same manner as described in Example 1 to provide lithium nitrate on the fracture surface and the surface of the positive electrode active material. A nonaqueous electrolyte secondary battery using this positive electrode is referred to as Battery 16.

Batteries 1-16, and Batteries C1-C9, which were rectangular nonaqueous electrolyte secondary batteries, were evaluated in the following manner.

Lithium salt except for lithium hydroxide and lithium carbonate produced in the positive electrode by the acid treatment was evaluated by X-ray photoelectron spectroscopy (XPS). An X-ray photoelectron spectrometer (ESCA1000) was used for the evaluation. A Mg—Kα X-ray source (1253.6 eV) was used as an X-ray source.

Whether lithium sulfate was produced or not was checked by spectrum peaks of Li (1 s) (binding energy: 55.7 eV), and S (2p3/2) (binding energy: 169 eV). Whether lithium nitrate was produced or not was checked by spectrum peaks of Li (1 s) (binding energy: 56.3 eV), and N (1 s) (binding energy: 407 eV). Whether lithium chloride was produced or not was checked by spectrum peaks of Li (1 s) (binding energy: 55.8 eV), and Cl (2p3/2) (binding energy: 198.5 eV). Whether lithium perchlorate was produced or not was checked by spectrum peaks of Li (1 s) (binding energy: 57.2 eV), and Cl (2p3/2) (binding energy: 206 eV). Whether lithium phosphate was produced or not was checked by spectrum peaks of Li (1 s) (binding energy: 55.8 eV), and P (2p3/2) (binding energy: 133 eV).

### Evaluation of Physical Properties of Nonaqueous Electrolyte Secondary Battery

### (1) Cycle Test

Nonaqueous electrolyte secondary batteries of Examples and Comparative Examples were charged and discharged under the following conditions at an environmental temperature of 45° C.

Each nonaqueous electrolyte secondary battery was charged at a maximum current of 0.9 A, and a constant voltage of 4.2 V. The charge was finished when the current value was reduced to 50 mA. Then, the battery was discharged at a constant current of 0.9 A. The discharge was finished when the voltage value was reduced to 3.0 V. A pause of 30 minutes was provided between the charge and the discharge. This charge/discharge cycle was performed 500 times. A ratio of discharge capacity at the 500^{th} cycle to discharge capacity at the 1^{st} cycle was represented in percentage to obtain capacity maintenance ratio (%).

### (2) Measurement of Thickness of Battery

Each of the nonaqueous electrolyte secondary batteries of Examples and Comparative Examples experienced 500 charge/discharge cycles, and was cooled to a battery temperature of 25° C. After the cooling, the thickness of the battery (mm) was measured when the battery temperature was 25° C., and the measured thickness was compared with the battery thickness before the cycle test.

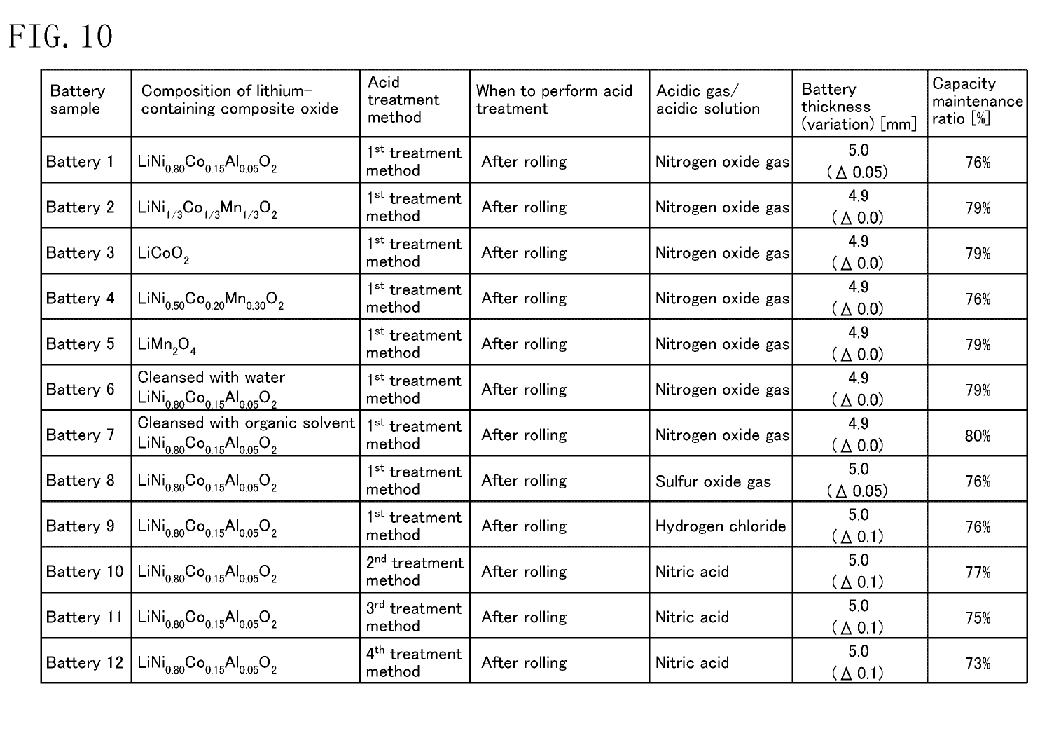

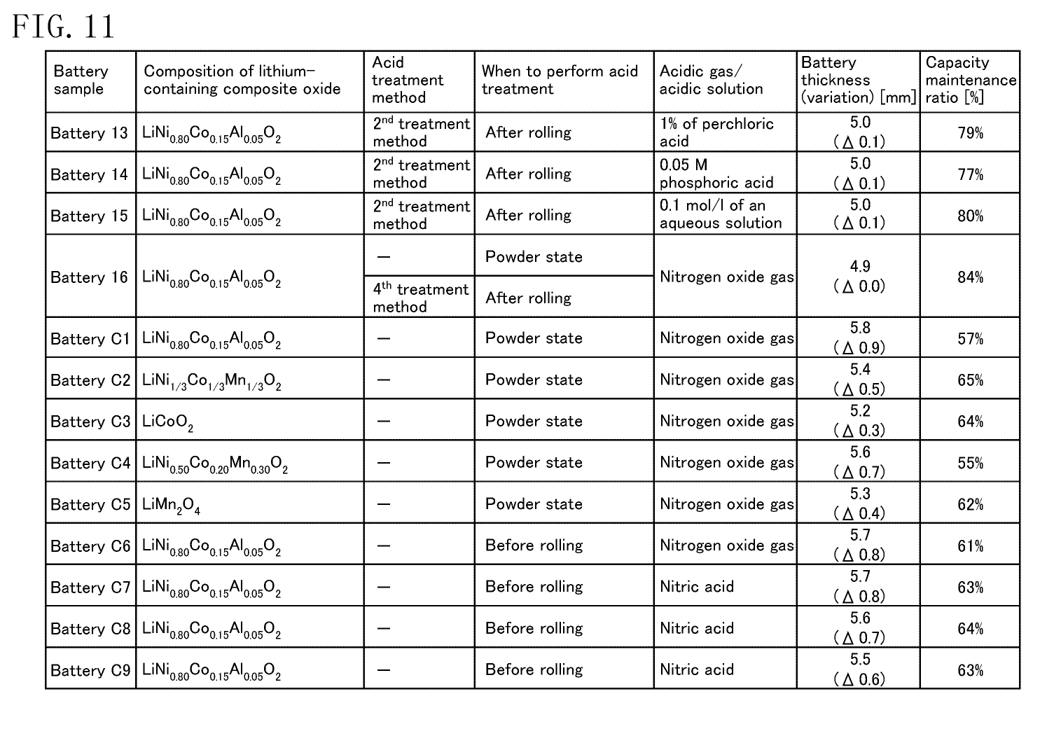

FIGS. 10 and 11 show the evaluation results. In FIGS. 10 and 11, “Battery thickness” indicates the thickness of the battery (mm) after the cycle test, and “Variation” indicates a value obtained by subtracting the thickness before the cycle test from the thickness after the cycle test (Δ/mm).

In comparison between Battery 1 and Battery C1 shown in FIGS. 10 and 11, Battery C1 which was not treated with the acidic gas increased in battery thickness after the test to show a variation in thickness as large as 0.9 mm, and generated a large amount of gas. In the composition of the gas generated by Battery C1, the ratio of CO₂ gas was increased. This indicates that lithium hydroxide and lithium carbonate were present near the surface of the active material LiNi_{0.80}Co_{0.15}Al_{0.05}O₂ reacted with the nonaqueous electrolyte solution to generate the CO₂ gas. By contrast, in Battery 1, lithium hydroxide produced by reaction between the baked active material LiNi_{0.80}Co_{0.15}Al_{0.05}O₂ and moisture in the air, and unreac lithium hydroxide were present near the surface of the positive electrode active material. However, lithium hydroxide present on the fracture surface and the active material surface was neutralized by bringing the nitrogen oxide gas into contact with the positive electrode active material, thereby producing neutral lithium nitrate, and alleviating the generation of gas due to decomposition of the electrolyte solution.

When lithium hydroxide remains on the surface of the active material, lithium hydroxide adsorbs carbon dioxide in the air, thereby producing lithium carbonate. However, neutralizing lithium hydroxide on the surface of the active material with the nitrogen oxide gas can alleviate the production of lithium carbonate. This can also alleviate decomposition reaction between lithium carbonate and the nonaqueous electrolyte solution.

Thus, generation of carbon dioxide in the charge/discharge reaction can be reduced, thereby providing a highly reliable battery which is free from expansion.

In comparison between Batteries 1 and Batteries C1 and C6-C9, Batteries C6-C9 experienced generation of carbon dioxide gas during the cycle test, and increased in battery thickness. Battery C6 experienced the acidic gas treatment before the rolling, and Battery C1 experienced the acidic gas treatment performed directly on the powdery active material. However, although the nitrogen oxide gas is brought into contact with the surface of the active material before the rolling to neutralize lithium hydroxide existing on the surface, the active material particles cannot withstand a compression pressure applied by the rolling, and are broken as shown in FIG. 9. In this case, the active material particles inside the material mixture layer 22 which are not neutralized are broken to form a new fracture surface 91, and a fracture surface 92 in the surface of the material mixture layer. Therefore, lithium hydroxide is produced on the fracture surfaces 91, 92 in the fabrication of the electrode, and lithium carbonate is produced, thereby causing generation of carbon dioxide in the cycle test.

The acid treatment performed before the rolling cannot alleviate the generation of gas is clarified from a comparison between Batteries 2 and C2 in which LiMn_{1/3}Ni_{1/3}Co_{1/3}O₂ was used as the active material, a comparison between Batteries 3 and C3 in which LiCoO₂ was used as the active material, a comparison between Batteries 4 and C4 in which LiNi_{0.50}Co_{0.20}Mn_{0.30}O₂ was used as the active material, and a comparison between Batteries 5 and C5 in which LiNi_{0.50}Co_{0.20}Mn_{0.30}O₂ was used as the active material. The acid treatment performed after the rolling alleviated the generation of gas during the cycle test, and maintained the capacity.

On the other hand, Battery 16 in which the acid treatment was performed on the powdery active material, and on the rolled positive electrode was able to alleviate the generation of gas, like Battery 1. Battery 16 showed the variation in battery thickness similar to that of Battery 1, and improved in capacity maintenance ratio after the cycles. A presumable cause of this phenomenon is that the generation of gas was alleviated, thereby alleviating retention of gas in the electrode which may affect the battery thickness.

In Batteries 6 and 7, the powdery active material from which lithium hydroxide was removed by cleansing the active material LiNi_{0.80}Co_{0.15}Al_{0.05}O₂ used in Battery 1 was use and the acid treatment was performed after the rolling. The XPS measurement showed that cleansing the powdery active material allowed removal of lithium hydroxide and lithium carbonate contained in the active material during the manufacture of the active material. Further, due to the acid treatment performed after the rolling, the amount of gas generated after the cycle test was reduced as compared with Battery 1, and the capacity characteristics were maintained.

The alleviation of the generation of gas according to this embodiment is presumably achieved by producing lithium salt except for lithium carbonate on the fracture surface of the positive electrode active material, and the surface of the positive electrode active material by the acid treatment to neutralize lithium hydroxide. Due to the production of lithium salt, generation of carbon dioxide gas on the surface of the active material is alleviated. This can alleviate generation of carbon dioxide produced by reaction of lithium hydroxide or lithium carbonate. As a result, a nonaqueous electrolyte secondary battery which has highly reliable charge/discharge characteristics, can keep high capacity maintenance ratio even after 500 charge/discharge cycles, and would not increase in battery thickness can be fabricated with high productivity.

Batteries 1 and C1, Batteries 2 and C2, Batteries 3 and C2, Batteries 4 and C4, and Batteries 5 and C5 are compared in terms of the reduction in variation of battery thickness, i.e., the alleviation of the generation of gas. As a result, LiNi_{0.80}Co_{0.15}Al_{0.05}O₂, LiNi_{0.5}Co_{0.2}Mn_{0.3}O₂, and LiMn_{1/3}Ni_{1/3}Co_{1/3}O₂, each of which is lithium-containing composite oxide containing nickel, are particularly effective in alleviating the increase in battery thickness. Thus, a nonaqueous electrolyte secondary battery having high capacity density can be obtained.

In Batteries 8 and 9, the rolled positive electrodes were acid-treated with sulfur oxide gas, and hydrogen chloride gas, respectively, to produce lithium salt. Like Battery 1, the production of lithium salt using the acidic gas except for carbon dioxide alleviated the generation of gas.

In Batteries 10-15, the acid treatment was performed with the acidic solution, by spraying or penetrating diluted nitric acid. In any of the treatment methods, lithium salt was favorably produced on the surface of the positive electrode active material. This indicates that any of the treatment methods is effective in alleviating the increase in battery thickness, and maintaining the capacity.

As a result of analysis of Batteries 1-16 by TEM, lithium salt except for lithium hydroxide and lithium carbonate was present on the surface and the fracture surface of the particulate positive electrode active material, and lithium hydroxide and lithium carbonate were hardly found. On the other hand, as a result of analysis of Batteries C1-C9 by TEM, lithium salt except for lithium hydroxide and lithium carbonate was present on the original surface of the particulate positive electrode active material (before break due to the rolling), while lithium hydroxide and lithium carbonate were present, and lithium salt except for lithium hydroxide and lithium carbonate was hardly found on the fracture surface of the particulate positive electrode active material.

### Other Embodiments

The above-described embodiment and examples have been described only for the illustration of the present invention, and the invention is not limited to the embodiment and the examples. For example, the above-described embodiment has been described based on a nonaqueous electrolyte secondary battery wound into a rectangular shape, but the invention can also be applied to flat batteries, batteries wound into a cylindrical shape, coin-shaped stacked batteries, laminated batteries, etc. Further, the embodiment has been directed to a battery for small-size devices, but needless to say, the invention can also be applied to large-size, high capacity batteries used as power sources for electric vehicles, or for stationary energy storage.

In Comparative Examples described above, the acid treatment (blowing the acidic gas, spraying the acidic solution, immersion into the acidic solution) has been finished before the rolling (compression) of the positive electrode material mixture layer. Accordingly, the generation of gas in the battery was not reduced. When the acid treatment is performed before and after the rolling, the generation of gas in the battery can effectively be reduced.

In the above-described embodiment, the acid treatment performed simultaneously with the rolling allows acid to act on the fracture surface of the positive electrode active material, thereby offering advantages similar to those of the acid treatment performed after the rolling. The acid treatment may be performed simultaneously and after the rolling.

### INDUSTRIAL APPLICABILITY

According to the present invention, generation of carbon dioxide due to reaction between lithium hydroxide and lithium carbonate with the nonaqueous electrolyte solution in the battery can be alleviated. Thus, a highly reliable nonaqueous electrolyte secondary battery which has good charge/discharge cycle characteristics, and is free from increase in battery thickness can be fabricated with high productivity.

### Description of Reference Characters

1 Negative electrode
2 Positive electrode
3 Separator
4 Electrode group
5 Battery case
6 Sealing plate
7 Positive electrode lead
8 Plug
9 Negative electrode lead
10 External connection terminal for positive electrode
11 Frame
22 Positive electrode material mixture layer
23 Positive electrode active material
24, 91 Fracture surface of positive electrode active material
25, 92 Fracture surface of positive electrode active material in electrode surface
26 Surface of positive electrode active material
24a, 25a, 26a Lithium salt
27 Mixture portion comprising binder and conductive agent
31 Roller
32 Chamber
33, 41, 63 Nozzle
34 Acidic gas
42, 62 Acidic solution
51 Transfer roller
61 Support roller
64 Inert gas
65 Immersion bath

1. A positive electrode for a nonaqueous electrolyte secondary battery comprising:
a current collector; and a positive electrode material mixture layer formed on the current collector, wherein
the positive electrode material mixture layer contains a particulate positive electrode active material which is capable of reversibly inserting and extracting lithium ions, and has a density of 2.4 g/cm³ or higher, and
lithium salt except for lithium hydroxide and lithium carbonate is present at least on a surface of the particulate positive electrode active material.

2. The positive electrode for the nonaqueous electrolyte secondary of claim 1, wherein
the lithium salt is at least one selected from the group consisting of lithium sulfate, lithium nitrate, lithium chloride, lithium perchlorate, and lithium phosphate.

3. A method for fabricating a positive electrode for a nonaqueous electrolyte secondary battery comprising:
forming a positive electrode material mixture layer containing a particulate positive electrode active material capable of reversibly inserting and extracting lithium ions on a current collector;
compressing the positive electrode material mixture layer to a predetermined thickness; and
blowing acidic gas except for carbon dioxide gas on the positive electrode material mixture layer.

4. The method for fabricating the positive electrode for a nonaqueous electrolyte secondary battery of claim 3, wherein
the blowing of the acidic gas is performed at least simultaneously with the compressing, or after the compressing.

5. The method for fabricating the positive electrode for a nonaqueous electrolyte secondary battery of claim 3 or 4, wherein
the acidic gas is at least one selected from the group consisting of sulfur oxide, nitrogen oxide, hydrogen chloride, and chlorine.

6. A method for fabricating a positive electrode for a nonaqueous electrolyte secondary battery comprising:
forming a positive electrode material mixture layer containing a particulate positive electrode active material capable of reversibly inserting and extracting lithium ions on a current collector;
compressing the positive electrode material mixture layer to a predetermined thickness;
spraying an acidic solution except for a carbon dioxide solution on the positive electrode material mixture layer; and
drying the positive electrode material mixture layer after the spraying.

7. The method for fabricating the positive electrode for the nonaqueous electrolyte secondary battery of claim 6, wherein
the spraying of the acidic solution is performed at least simultaneously with the compressing, or after the compressing.

8. A method for fabricating a positive electrode for a nonaqueous electrolyte secondary battery comprising:
forming a positive electrode material mixture layer containing a particulate positive electrode active material capable of reversibly inserting and extracting lithium ions on a current collector;
compressing the positive electrode material mixture layer to a predetermined thickness;
immersing the positive electrode material mixture layer into an acidic solution except for a carbon dioxide solution; and
drying the positive electrode material mixture layer after the immersing.

9. The method for fabricating the positive electrode for the nonaqueous electrolyte secondary battery of claim 8, wherein
the immersing is performed at least simultaneously with the compressing, or after the compressing.

10. The method for fabricating the positive electrode for the nonaqueous electrolyte secondary battery of any one of claims 6 to 9, wherein
an acid ion contained in the acidic solution is at least one selected from the group consisting of a sulfuric acid ion, a sulfurous acid ion, a nitric acid ion, a phosphoric acid ion, and a chloride ion.

11. A nonaqueous electrolyte secondary battery comprising:
the positive electrode for the nonaqueous electrolyte secondary battery of claim 1 or 2, a negative electrode, and a nonaqueous electrolyte.
